(19) United States
(12) Patent Application Publication
(10) Pub. No.: US 2011/0039582 A1
(43) Pub. Date: Feb. 17, 2011

(54) FLEET MANAGEMENT SYSTEM AND METHOD

(75) Inventor: Lawrence Kendall, Londonderry (GB)

Correspondence Address: PEPPER HAMILTON LLP, ONE MELLON CENTER, 50TH FLOOR, 500 GRANT STREET, PITTSBURGH, PA, 15219, US

(73) Assignee: LAWRENCE KENDALL.COM LTD., Londonderry, GB (UK)

(21) Appl. No.: 12/158,030

(22) PCT Filed: Dec. 19, 2006
(86) PCT No.: PCT/GB2006/004778

§ 371 Date: Oct. 17, 2008

(30) Foreign Application Priority Data
Dec. 19, 2005 (GB) 0525758.9

(51) Int. Cl. H04W 4/02

(52) U.S. Cl. 455/456.5

(57) ABSTRACT

A fleet management system comprises a server, a plurality of dispatch terminals remote from the server, and a telecommunications gateway. The server connects to the telecommunications gateway and to the dispatch terminal. The telecommunications gateway receives request data from a communication device via a telecommunication network, which comprises an indication of a location of the communication device and an identifier associated with the communication device. The telecommunication gateway transfers the request data to the server. The server determines a geographically suitable dispatch terminal and transmits data corresponding to the contents of the request data to the suitable dispatch terminal. The dispatch terminal receives an input as to whether to accept or reject the request data, and if accepted to forward response data comprising at least identifier data to the telecommunications gateway via the server. The telecommunications gateway transmits the response data to the communication device via the telecommunications network.

### CROSS-REFERENCE TO RELATED APPLICATIONS

This patent application claims priority to Great Britain Patent Application Number 0525758.9, filed Dec. 19, 2005. The application was also filed as International Patent Application PCT/GB2006/004778 with an international filing date of Dec. 19, 2006, with subsequent publication as International Publication Number WO 2007/071976 on Jun. 28, 2007. The disclosures of each of the aforementioned documents are incorporated herein by reference in their entireties.

### BACKGROUND

This invention relates to a fleet management system and method. More particularly, but not exclusively, the invention relates to a fleet management system and method for the management of a fleet of taxis.

Currently a potential taxi passenger must telephone a taxi company and request that a taxi is sent to their location. In some taxi companies an operator keeps a simple paper log of these passenger requests. In other taxi firms an operator at a computer terminal assigns a driver to the passenger. Such a system has a number of disadvantages associated with it.

Deaf passengers or those with impaired hearing may experience difficulties in ordering a taxi due to the current bias towards telephony in taxi dispatch systems.

The passenger has no idea of the identity of the driver or of the vehicle that the driver will be using. This raises issues regarding the personal safety of the passenger, particularly for young women, as they have no knowledge of who is arriving to collect them.

Typically every taxi company has a different telephone number. This requires the passenger to use a number particular to their locality at the time of requesting the taxi. This is a particular problem where the passenger is not familiar with their locality, this can require the passenger to request a local telephone number from directory enquiries. Requesting a telephone number form directory enquiries has an associated cost, and occupies telecommunications infrastructure. In those companies that have a computerised booking system, the use of a generic personal computer as the computer terminal presents security risks for the taxi company as viruses can be downloaded from the Internet. The operator can access the Internet resulting in personal use of the computer during work hours.

A large number of taxi companies operate with drivers who are not registered and who may not even be insured.

Additionally, taxi companies suffer from requests for their services that are either malicious, for instance where the alleged passenger does not require the taxi, or where the passenger occupies a taxi other than that which they requested. This results in a significant wastage of fuel, resources and money. The increased usage of fuel has environmental implications.

### SUMMARY

According to a first aspect of the present invention there is provided a fleet management system comprising a server, a plurality dedicated dispatch terminals remote from the server, and a telecommunications gateway, the server being connected to the telecommunications gateway and to the dispatch terminal, the telecommunications gateway being arranged to receive request data from a communication device via a telecommunication network, the request data comprising at least an indication of a location of the communication device and an identifier associated with the communication device, the telecommunication gateway being further arranged to transfer the request data to the server, the server being arranged to determine the location of the communication device from the content of the request data, the server being further arranged to determine a geographically suitable dispatch terminal and to transmit data corresponding to the contents of the request data to the suitable dispatch terminal, the dispatch terminal being arranged to receive an input as to whether to accept or reject the request data, and if accepted to forward response data comprising at least driver identifier data and vehicle identifier data to the telecommunications gateway via the server, the telecommunications gateway being arranged to transmit the response data to the communication device via the telecommunications network.

Such as system provided a passenger with the identity of the vehicle and the driver that is coming to collect them with an attendant increase in personal security of passenger. Additionally, a list of registered and insured drivers may be maintained centrally and only those drivers who are on this register may be allocated jobs.

The use of dedicated dispatch terminals that connect only with the server increases the security of the system. This reduces the amount of downtime associated with viruses etc. The increase security also prevents unauthorised personal use of the terminal for Internet access.

Forwarding the passenger's identifier, typically a telephone number, allows call screening to identify persistent malicious callers etc. This reduces fuel wastage and other wastage of resources.

Also, only those taxi companies who have subscribed to use the system and are enabled by the service provided will be able to login to the system and thereby receive passengers' requests.

The telecommunication gateway may have a single identifier associated therewith, typically a telephone number, text message number or e-mail address. The request data may be in any of the following formats: short message service (SMS) text message, multi-media message service (MMS), simple mail transfer protocol (SMTP) e-mail.

The use of text based systems improves the accessibility of the system to deaf or hearing impaired passengers over current systems.

The system also provides a single number that can be used for the requesting a taxi anywhere within a country, that of the gateway. This reduces, or eliminates the need for multiple numbers to be used and also reduces the need for calls to directory enquiries.

The server may be arranged to identify a character string that identifies data received from the telecommunication gateway as request data. The server may be arranged to discard data identified as non-request data.

Such a discrimination of data prevents the further processing of non-request data and thereby reduces the processing load at the server.

The server may be arranged to locate the location data within the request data and extract the location data therefrom. The server may be arranged to analyse at least a portion of a character string within the request data to determine the location of the communication device. The server may be arranged to compare the at least a portion of the character string to entries in a data structure.

The data structure may comprise entries correlating geographical locations with at least one supplier of taxi services in a respective geographical location. The system automatically determines which taxi firm is in a suitable geographical location for the location received in the request data.

The server may be arranged to transmit data corresponding to the contents of the request data to a second geographically suitable dispatch terminal, if the first dispatch terminal rejects the request data.

This allows a request for a taxi to be forwarded to a second company should a first company reject the request.

The server and the plurality of dispatch terminals may be connected via respective broadband communication channels, for example via a virtual private network.

The server may be arranged to allocate request data to geographically proximate dispatch terminals based upon the number of vehicles available for dispatch by each terminal.

The allocation of requests dependent upon the number of vehicles available increase the efficiency of provision of taxi services to passengers.

The server may host a web based service in which a user enters device identifier data associated with a communication device, for example their mobile telephone number, and also an user identifier data associated with the user, for example their name, at a remote terminal, for example a PC, mobile telephone or personal digital assistant (PDA).

The server may be arranged to construct a user data structure comprising entries corresponding to the user identifier data and the device identifier data. The server may access the user data structure upon receipt of request data and may determine if an entry in the user data structure corresponds to device identifier data and entering the user identifier data in the response data.

The personalisation of the system via a web interface improves user appeal of the system.

The server may be arranged to receive hotspot data from a user of the web service comprising a shortcode and a geographical location and to associate the shortcode with the user's entry in the user data structure. The server may access the user data structure upon receipt of request data and may determine if an entry in the user data structure corresponds to device identifier data and if the shortcode is present in the request data, and if the shortcode is present in the request data to forward data corresponding to the request data to a suitable dispatch terminal.

The use of shortcode hotspot data simplifies the use of the system for regular users of the system.

According to a second aspect of the present invention there is provided a server arranged to function as the server of the first aspect of the present invention.

According to a third aspect of the present invention there is provided a dispatch terminal arranged to function as one dispatch terminal of the plurality of dispatch terminals of the first aspect of the present invention.

According to a fourth aspect of the present invention there is provided a method of fleet management comprising the steps of: receiving request data comprising at least an indication of a location of the communication device and an identifier associated with the communication device from a communication device via a telecommunication network at a communications gateway; transferring the request data from the gateway to a server; determining, at the server, the location of the communication device from the content of the request data and a geographically suitable dispatch terminal; transmitting data corresponding to the contents of the request data to the suitable dispatch terminal; receiving, at the dispatch terminal, an input as to whether to accept or reject the request data and if accepted forwarding response data comprising at least driver identifier data and vehicle identifier data to the telecommunications gateway via the server; and transmitting the response data from the telecommunications gateway to the communication device via the telecommunications network.

The method may comprise identifying a character string that identifies data received from the telecommunication gateway as request data. The method may comprise discarding data identified as non-request data.

The method may comprise locating the location data within the request data and extracting the location data therefrom. The method may comprise analysing at least a portion of a character string within the request data to determine the location of the communication device. The method may comprise comparing the at least a portion of the character string to entries in a data structure comprising entries correlating geographical locations with at least one supplier of taxi services in a respective geographical location. The method may comprise transmitting data corresponding to the contents of the request data to a second geographically suitable dispatch terminal, if the first dispatch terminal rejects the request data.

The method may comprise allocating request data to geographically proximate dispatch terminals based upon the number of vehicles available for dispatch by each terminal.

The method may comprise hosting a web based service at the server in which a user enters device identifier data associated with a communication device and also an user identifier data associated with the user at a remote terminal.

The method may comprise constructing a user data structure comprising entries corresponding to the user identifier data and the device identifier data. The method may comprise accessing the user data structure upon receipt of request data and may determine if an entry in the user data structure corresponds to device identifier data and entering the user identifier data in the response data.

The method may comprise receiving hotspot data from a user of the web service comprising a shortcode and a geographical location and to associate the shortcode with the user's entry in the user data structure. The method may comprise accessing the user data structure upon receipt of request data and may determine if an entry in the user data structure corresponds to device identifier data and if the shortcode is present in the request data, and if the shortcode is present in the request data to forward data corresponding to the request data to an suitable dispatch terminal. According to a fifth aspect of the present invention there is provided a data carrier bearing software, which when executed upon a processor, causes the processor to act as the server of the first aspect of the present invention.

The data carrier may be any of the following: a magnetic disc, flash memory, eeprom, a digital versatile disc, a compact disc.

### BRIEF DESCRIPTION OF THE DRAWINGS

The invention will now be described, by way of example only, with reference to the accompanying drawings, in which:

FIG. 1 is a schematic representation of an embodiment of a fleet management system according to an aspect of the present invention;

FIG. 2 is an image of an output screen viewed on a dispatch terminal of the system of FIG. 1; and

FIG. 3 is a flow diagram showing a method of fleet management according to an aspect of the present invention.

### DETAILED DESCRIPTION

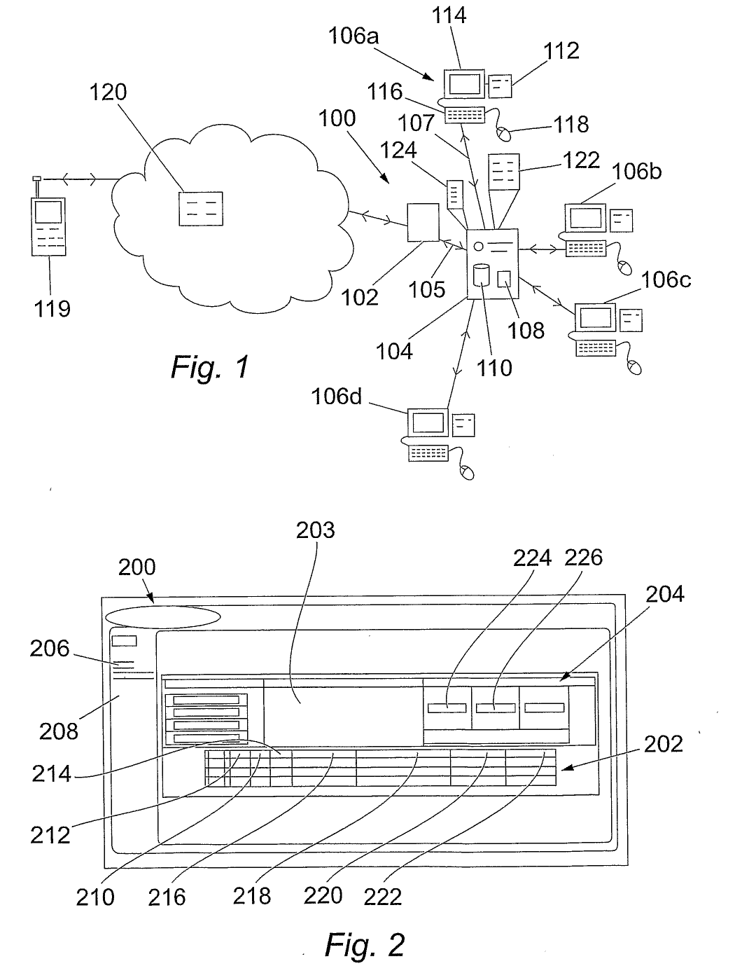

Referring now to FIGS. 1 and 2, a fleet management system 100 comprises a telecommunication gateway 102, a server 104, and a number of dispatch terminals 106a-d, for example dedicated DELL terminals. Typically, the server 104 will be a Windows(™) 2003 server, a server with one to one contention or an SQL server. The server 104 allows remote access for remote maintenance and updating software.

The dispatch terminals 106 a-d are distributed in towns and cities. Typically, each taxi firm in a town will have a dispatch terminal 106. In a preferred embodiment, the gateway 102 is in direct communication with the server 104 via a broadband connection or GPRS, for example an asynchronous digital logic (ASDL) connection. In another embodiment the gateway 102 may be incorporated within the server 104.

The server 104 comprises a processor 108, for example an Intel Pentium processor, and a data storage device 110, for example a magnetic disc, a DVD or a CD. The server 104 communicates with the dispatch terminal 106 via a broadband connection 107, for example asynchronous digital logic (ASDL).

Each dispatch terminal 106a-d comprises a processor 112, a screen 114, a keyboard 116 and a mouse 118. Usually, the dispatch terminals 106a-d allow access only to appropriate URLs and to execute only software appropriate for the running of the system 100.

In use, a passenger who requires a taxi uses a mobile telephone 119 to enter an SMS text message 120. The passenger sends the SMS text message 120 to a telephone number corresponding to the telecommunication gateway 102, for example “82820”.

The content of the SMS text message 120 typically comprises a message of the form:

TAXI (town) FROM (location) TO (location)

The location need not be a place name as the server 104 may have a list of “hot spot” abbreviations. For example, SLV1 may be the south entrance of the Liffey Valley shopping centre. An alternative manner of determining the pick up location of a passenger is to use interrogate the telephony network in order to obtain the cell location of a cell phone user.

Additional information such as the desired pick up time or other preferences can be suffixed to a message of the above format.

The telecommunication gateway 102 passes the SMS text message 120 to the server 104. The telecommunications gateway 102 is arranged such that the users of the service can text a taxi from anywhere in the world using one number that is allocated to their home network. For example, the UK number 82820 is used for UK registered handsets but the user can also use the same number to book a taxi if they are in a different country.

Processor 108 searches the character string of the SMS text message 120 for the word “TAXI”, if the word is not found the processor 108 determines that the text message 120 is not a valid request for a taxi and discards it. Should the SMS text message 120 contain the word “TAXI” the processor 108 searches the character string of the SMS text message 120 for the name of a town directly following the word “TAXI”.

The processor 108 then extracts the town name from the SMS text message 120 and accesses a membership data structure 122 stored on the data storage device 110. The processor 108 compares the town name extracted from the SMS text message to the entries in the data structure 122 to determine if there is a match. If there is no match, the server 104 sends a text message to the mobile telephone 119 via the telecommunication gateway 102 informing the passenger that there is no taxi company using the system in their current locality. If a match is found between the extracted town name and an entry in the membership data structure 122 the processor 108 allocates the passenger to a company in their current locality. In one embodiment, where there are multiple taxi companies in a given locality the processor 108 determines which company will be allocated the passenger based upon the number of available taxis that each firm has. For example, a firm having fifty taxis will be allocated twice as many passengers as a firm having twenty five taxis. The server 104 maintains a history of previous allocations on the data storage device 110 in order to produce a distribution of passenger allocations in accordance with this, or any other suitable, model.

Once a passenger request is allocated data corresponding to the passenger's request is passed via the broadband connection 107 to the dispatch terminal 106a corresponding to the firm allocated the passenger.

The screen 114 of the dispatch terminal 106a displays a graphical user interface (GUI) 200.

The GUI 200 comprises data fields corresponding to passengers requests 202, detailed message fields 203 reply buttons 204, driver list menu 206 and a historical message history menu 208.

The request message fields 202 comprise a status field 210, a job ID field 212, a user ID field 214, a received time field 216, a message field 218, a passenger name field 220 and a telephone number field 222.

Each request is displayed in a respective request message field 202 with the most recent request being displayed in the uppermost field. The status field 210 indicates whether the job is new “N”, has been accepted “A”, or has been completed “C”. The job ID field 212 displays the identifier assigned to each job. The user ID field 214 displays an identifier assigned to a user when the make a request. The received time field 216 displays the time at which the request was received at the server 104. The telephone number field 222 shows the telephone number of the telephone from which the request was made.

The message field 218 displays the portion of the request following the town in which the dispatch terminal 106a is located, i.e. FROM (location) TO (location), in order to allow a dispatcher to view where passenger's intended journey.

In one embodiment, the passenger name field 220 will remain unused. However, in a preferred embodiment, passengers will be able to enter their name and an associated telephone number via a web site interface hosted on the server 104, or from an interface hosted on their mobile telephone. The processor 108 then builds a user data structure 124 containing these cross-referenced telephone numbers and names that is stored upon the data storage device 110. It is envisage that a user of the system would enter their home address details that would be stored in the user data structure 124. This allows the passenger to simply enter the word “HOME” as their destination in the SMS text message 120. The data passed from the server 104 to the dispatch terminal 106a includes passengers home address details so that this can be displayed automatically on the screen 114.

The user data structure 124 is accessed by the processor 108 upon receipt of a request from the telecommunication gateway 102. If the telephone number from which the request was made is stored in the user data structure 124 the processor 108 extracts the name corresponding to the telephone number. This name is added to the data sent to the dispatch terminal 106a and is displayed in the passenger name field 220.

A dispatcher uses the mouse 118 to select a job from the request message field 202, this activates the reply buttons 204. The reply buttons comprise an accept button 224, a decline button 226 and a completed button 228. The dispatcher will also have the option to either select a message from a drop down menu or to enter tailored text in a text box within the GUI, for example to indicate to the user that they have not taxis available for a period of time.

Alternatively, the user may request a quotation from a minicab firm. In this instance the server 104 recognizes the character string “QUOTE” within the text message. The server 104 then distributes the request to a number of geographically suitable minicab firms which can reply with quotations for the journey detailed in the text message, typically three firms. The user can then decide which, if any, of the minicab firms to reply to requesting that a minicab is sent to them, the software then processes this request in the normal way.

A dispatcher can select to view a request and the detailed request message is displayed in the detail message field 203.

If the dispatcher selects the accept button 224 the status of the job is changed from “N” to “A” in the status field 210. The dispatcher then selects a driver to carry out the job, typically from the driver list menu 206. The driver list menu 206 comprises a list of drivers and their associated vehicle registration plate details. The dispatch terminal 106a transmits data corresponding to acceptance of the job, the job ID and the driver details to the server 104. The server 104 generates SMS text message format response data 126. The SMS text message data 126 typically includes a greeting, which may be personalized if the recipient is a member of the web based service, details of the taxi firm, driver and vehicle registration that is dealing with the job. The server 108 forwards the response data 126 to the mobile telephone 119 where it is displayed, via the telecommunication gateway 102. The passenger is made aware of the taxi firm, driver and registration details of the vehicle dealing with their request.

Once the job is completed the dispatcher again selects the job from the request message fields 202, which activates the reply buttons 204. The dispatcher then selects the completed button 228, this changes the job status from accepted to completed. Generally, the job details are stored at the server 104 in accordance with local data retention requirements in order to give accountability of drivers and firms.

Should a job be declined, by selecting a job from the request message fields 202 and then selecting the decline button 226, the request is passed back to the server 104 where a second taxi company in the selected town is chosen and the request is transmitted to the dispatch terminal 106b of the second company.

The display of a passenger's telephone number allows a dispatcher, either through their own experience or through a compiled list of numbers, to identify frequent nuisance passengers and passenger who make multiple requests in order to ensure a taxi arrive and decline jobs from these passengers. This function may be automated with the dispatch terminals 106a-d being programmed to automatically reject requests from previously identified passengers.

In a preferred embodiment, the server 104 receives hotspot data input by a passenger using the web based service. This hotspot data comprises a short-code and a geographical location associated with the short-code, for example “MGD—(Pothouse Belfast)”. The processor 108 associates this short-code with the user's entry in the user data structure. The processor 108 accesses the user data structure 124 upon receipt of request data. If a short-code entry in the user data structure 124 for an appropriate passenger corresponds part of the request data the server 104 forwards the request data to a suitable dispatch terminal 106a.

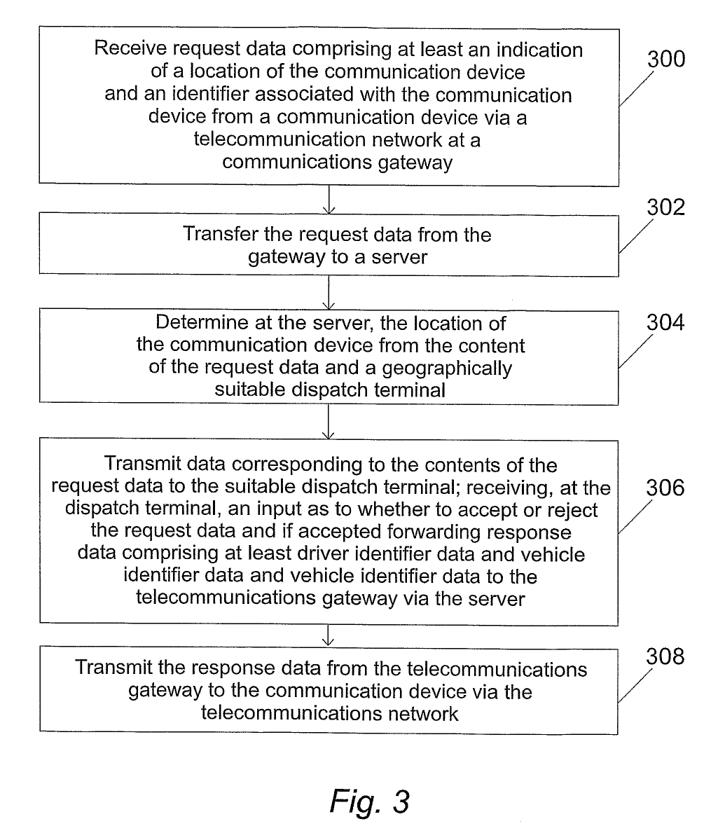

Referring now to FIG. 3, a method of fleet management comprises receiving request data including a location of a potential passenger and a telephone number, from a telephone, usually a mobile telephone, typically in the form of a text message, via a telecommunications gateway (Step 300). The request data is transferred from the gateway to a server (Step 302). The server determines the location of the passenger from the content of the request data (Step 304). The server transmits data corresponding to the contents of the request data to a suitably located dispatch terminal (Step 306). The dispatch terminal receives an input as to whether to accept or reject the request data (Step 308). If the request is accepted, response data identifying the driver and the vehicle registration is transmitted to the telecommunications gateway via the server.

The telecommunication gateway transmits the response data to the telephone via the telecommunications network. (Step 310) It will be appreciated that although described with reference to telephone, and in particular mobile telephones, any form of text based electronic data transfer may be used in the present invention, for example e-mail.

What is claimed is:

1. A fleet management system comprising:
a server;
a plurality of dispatch terminals remote from the server; and a telecommunications gateway,
the server being connected to the telecommunications gateway and to the dispatch terminal,
the telecommunications gateway being arranged to receive request data from a communication device via a telecommunication network,
the request data comprising at least an indication of a location of the communication device and an identifier associated with the communication device,
the telecommunication gateway being further arranged to transfer the request data to the server,
the server being arranged to determine the location of the communication device from the content of the request data, the server being further arranged to determine a geographically suitable dispatch terminal and to transmit data corresponding to the contents of the request data to the suitable dispatch terminal,
the dispatch terminal being arranged to receive an input as to whether to accept or reject the request data, and if accepted to forward response data comprising at least identifier data to the telecommunications gateway via the server,
the telecommunications gateway being arranged to transmit the response data to the communication device via the telecommunications network.

2. The system of claim 1, wherein the telecommunication gateway has a single identifier associated therewith.

3. The system of claim 2, wherein the single identifier is any of: a telephone number, text message number or e-mail address.

4. The system of claim 2, wherein the single identifier is uniform within a country.

5. The system of claim 1, wherein the request data is in any of the following formats: short message service (SMS) text message, multi-media message service (MMS), or simple mail transfer protocol (SMTP) e-mail.

6. The system of claim 1, wherein the server is arranged to identify a character string that identifies data received from the telecommunication gateway as request data.

7. The system of claim 6, wherein the server is arranged to discard data identified as non-request data.

8. The system of claim 1, wherein the server is arranged to locate the location data within the request data and extract the location data therefrom.

9. The system of claim 1, wherein the server is arranged to analyse at least a portion of a character string within the request data to determine the location of the communication device.

10. The system of claim 8, wherein the server is arranged to compare the at least a portion of the character string to entries in a data structure.

11. The system of claim 10, wherein the data structure comprises entries correlating geographical locations with at least one supplier of taxi services in a respective geographical location.

12. The system of claim 1, wherein the server is arranged to transmit data corresponding to the contents of the request data to a second geographically suitable dispatch terminal, if the first dispatch terminal rejects the request data.

13. The system of claim 1, wherein the server and the plurality of dispatch terminals are connected via respective broadband communication channels.

14. The system of claim 1, wherein the server is arranged to allocate request data to geographically proximate dispatch terminals based upon the number of vehicles available for dispatch by each terminal.

15. The system of claim 1, wherein the server is arranged to host a web based service in which a user enters device identifier data associated with a communication device and an user identifier data associated with the user at a remote terminal.

16. The system of claim 15, wherein the server is arranged to construct a user data structure comprising entries corresponding to the user identifier data and the device identifier data.

17. The system of claim 16, wherein the server is arranged to:
access the user data structure upon receipt of request data;
determine if an entry in the user data structure corresponds to device identifier data; and
enter the user identifier data in the response data.

18. The system of claim 16, wherein the server is arranged to receive hotspot data from a user of the web service comprising a shortcode and a geographical location and to associate the shortcode with the user's entry in the user data structure.

19. The system of claim 18, wherein the server is arranged to:
access the user data structure upon receipt of request data;
determine if an entry in the user data structure corresponds to device identifier data;
determine if the shortcode is present in the request data; and
if the shortcode is present in the request data, forward data corresponding to the request data to an suitable dispatch terminal.

20. The system of claim 1, wherein at least one of the plurality of dispatch terminals is arranged to disable browsing of the Internet.

21. (canceled)

22. (canceled)

23. A method of fleet management, the method comprising:
receiving request data comprising at least an indication of a location of a communication device and an identifier associated with the communication device from the communication device via a telecommunication network at a communications gateway;
transferring the request data from the gateway to a server;
determining, at the server, the location of the communication device from the a content of the request data and a geographically suitable dispatch terminal;
transmitting data corresponding to the contents of the request data to the suitable dispatch terminal;
receiving, at the dispatch terminal, an input as to whether to accept or reject the request data and if accepted forwarding response data comprising at least identifier data to the telecommunications gateway via the server; and
transmitting the response data from the telecommunications gateway to the communication device via the telecommunications network.

24. The method of claim 23, further comprising identifying a character string that identifies data received from the telecommunication gateway as request data.

25. The method of either claim 23, further comprising locating the location data within the request data and extracting the location data therefrom.

26. The method of claim 23, further comprising analysing at least a portion of a character string within the request data to determine the location of the communication device.

27. The method of claim 23, further comprising comparing the at least a portion of the character string to entries in a data structure comprising entries correlating geographical locations with at least one supplier of taxi services in a respective geographical location.

28. The method of claim 23, further comprising transmitting data corresponding to the contents of the request data to a second geographically suitable dispatch terminal, if the first dispatch terminal rejects the request data.

29. The method of claim 23, further comprising allocating request data to geographically proximate dispatch terminals based upon the number of vehicles available for dispatch by each terminal.

30. The method of claim 23, further comprising hosting a web based service at the server in which a user enters device identifier data associated with a communication device and also an user identifier data associated with the user at a remote terminal.

31. The method of claim 30, further comprising constructing a user data structure comprising entries corresponding to the user identifier data and the device identifier data.

32. The method of claims 31, further comprising accessing the user data structure upon receipt of request data and determining if an entry in the user data structure corresponds to device identifier data and entering the user identifier data in the response data.

33. The method of either claim 31, further comprising receiving hotspot data from a user of the web service comprising a shortcode and a geographical location and to associate the shortcode with the user's entry in the user data structure.

34. The method of claim 33, further comprising:
accessing the user data structure upon receipt of request data;
determining if an entry in the user data structure corresponds to device identifier data; and
determining if the shortcode is present in the request data; and
if the shortcode is present in the request data, forwarding data corresponding to the request data to a suitable dispatch terminal.

35. (canceled)

36. (canceled)
